(19) United States
(12) Patent Application Publication
(10) Pub. No.: US 2004/0184044 A1
(43) Pub. Date: Sep. 23, 2004

(54) Method and apparatus for the automatic production of prints from digital photographic image data

(76) Inventors: Sebald Kolb, Munich (DE); Christophe Henry, Munich (DE); Dietmar Hensel, Emmering (DE); Bernd Kemmather, Munich (DE); Ullrich Kraemer, Munich (DE); Michael Siebenhandl, Riemerling (DE); Peter Wein, Munich (DE)

Correspondence Address: Karl F. Milde, Jr., Esq., MILDE & HOFFBERG, LLP, Suite 460, 10 Bank Street, White Plains, NY, 10606, US

(21) Appl. No.: 10/768,666

(22) Filed: Jan. 30, 2004

(30) Foreign Application Priority Data
Feb. 28, 2003 (EP) 03100514.3

(51) Int. Cl. B41J 1/00

(52) U.S. Cl. 358/1.1

(57) ABSTRACT

A method and apparatus for the automatic production of prints of digital photographic image data wherein the incoming image data are stored by order together with order data, and are presented in a sequence for processing. The image data are processed by order based on a processing sequence which includes both mandatory processing steps, to which the images of all orders are subjected, and optional processing steps to which the images of only specific orders are subjected. Prints are subsequently produced from the processed image data. The processing sequence of orders for subsequent processing steps is altered if the image data of one order pass through an optional processing step, thereby significantly increasing the processed order throughput of the system.

### BACKGROUND OF THE INVENTION

The invention relates to both a method and apparatus for the automatic production of prints from digital photographic image data.

At present, prints of photographic images are produced mainly by means of so-called digital “mini-labs”. These laboratory devices, such as may be found in 1-hour photographic laboratories, are capable of processing both digitally-captured data as well as conventional film. Images from digital cameras are passed through additional input devices, for example, or directly from digital input devices into the mini-lab. Conventional films are digitized by means of CCD cells or surfaces or by other sensors such as CMOS so that, after scanning these films, a digital file is also made available for further processing.

In the mini-lab, the input digital data are first subjected to input processing. In this, digital data arriving from an input device, the Internet, or directly-input data, are initially decompressed, if they were compressed for data transfer. The data scanned in from a film are subjected to scanner correction, whereby quiescent current at the sensor is taken into account, for example, along with other corrections that may be performed, such as scratch correction or edge falloff correction. After this input processing, digital image data exist that may be uniformly processed in subsequent image processing independent of their source.

So-called “order data” are added to the digital image data of an order such as a film or a series of photographs from a camera. These order data contain information regarding the image processing steps to be performed on the digital image data, output formats, selection of the type of output paper, or other diverse information necessary for the production of copies of these images. These order data may be added to digitally-input data in the camera or by using an input device. It is, however, also possible to define and establish these order data at the operator interface of the digital mini-lab for each order. The latter is performed in any event upon scanning of conventional films. Before a film is sampled, an order configuration is determined generally by the operator. Information for this is usually located on the order envelope in which the film to be copied was sent to the laboratory. These data usually located on the order envelope are input into the mini-lab by the operator. These data are, for example, output characteristics of the copies such as print format, 9×13, 10×15, etc., the paper type to be selected—i.e., matte or glossy—in other words, instructions regarding how the image data of these orders are to be treated. Thus, there may be a comment in the order data to the effect that a so-called “preview” is to be provided for this order. That is, the images of the order are to be displayed on the operator screen so that the operator may review their quality and perform manual corrections. Furthermore, there may be instructions that images from this order are to pass through red-eye detection and correction. This is advantageous, for example, when an order containing many images of persons is involved. After the order data is input on the operator screen, the inserted film is sampled, and order data such as image data from the pertinent order are compiled. The digital image data or data input by the sampling that were subjected to input processing and contain order data are stored in an input buffer.

The orders are taken from this input buffer and forwarded to image processing during which contrast compensation, focus enhancement, contrast modifications, red-eye corrections, color corrections, or manual corrections may be performed. These various image-processing steps are performed in sequence for every order, but some of these steps may also be performed in one image-processing step. Thus, for example, contrast modification may be coupled with focus enhancement in that a filter suitable for both corrections is applied to the image data. If a comment occurs in the order data that a preview is to be generated for this order so that the operator may undertake manual corrections, then this order is displayed on the operator screen. The operator must then review the images on the screen and enter any necessary correction values. These correction values are applied to the image data, and the operator can review the corrected image on the screen in order to check whether the result is acceptable. As soon as the images shown on the screen represent an image suitable for output, the operator releases them for further processing. The order may then be subjected to further image-processing steps, such as output processing, for example. During output processing, the image data are transformed into the color palette of the output device such as a printer or CD-burner, for example.

As soon as the entire image processing is completed, the order is subsequently issued. Upon issuance, prints of the images are created by projecting the image data onto photographic paper, for example. Such light-sensitive photographic paper must subsequently be developed in a paper developer that is also a component of the digital mini-lab. The mini-lab may, however, include an inkjet printer as the output device. In this case, image data are printed onto paper with ink. A developer may be omitted in this case. Thermal sublimation printers or similar are conceivable as output devices in digital mini-labs. In addition to the production of paper prints, the image data to be processed may be stored in digital storage media or transferred to another location with the Internet. Thus, digital mini-labs often include a CD burner or other digital output devices, and are often connected with the Internet.

The image data supplied to the digital mini-lab via various input devices are thus stored as an order along with other order data in an input buffer after specific input processing. The image data are subsequently subjected to image processing in sequential order, and then output in the order they were input by the output device of the digital mini-lab. In contrast to high-performance printers in major laboratories, these digital mini-labs have the disadvantage that their throughput is relatively low since they often require too much time to process an order.

### SUMMARY OF THE INVENTION

It is therefore a principal object of the present invention to develop a method and apparatus for the automatic production of prints from photographic digital image data by means of which orders may be processed more quickly.

This object, as well as other objects which will become apparent from the application that follows, are achieved, in accordance with the present invention, by providing a method and apparatus for automatic production of prints from digital photographic image data, wherein the image processing includes both mandatory processing steps that image data from all orders must pass through and optional processing steps that image data from only specific orders must pass through, wherein the processing sequence of the orders is altered for subsequent processing steps if the image data of an order are required to pass through an optional processing step.

Based on the invention, image processing in a digital mini-lab is so arranged that a subsequent order for the next processing step to be undertaken can be pushed forward, while an order is processed in a time-intensive image-processing step that is not required for the next order. Processing steps are provided in digital mini-labs that need not be performed for every order. There is either a statement in the order instructions as to whether these optional steps are to be performed, or the necessity of performing such a step is established during image processing. Although such an optional image-processing step is performed on one order, subsequent orders still to be processed that do not require the optional image-processing step may overtake the first order during image processing. Thus, starting with the next processing step, the processing sequence of the orders may be reversed. Also, the output order will be different than the one in which the orders were submitted. Although very time-intensive optional processing steps must be performed on one order, the next order need not await completion of the optional processing step as with conventional processors, but instead the next order that does not require this step is promoted, and can be processed independent of the time required to perform the optional step. Even if an order is stuck for several hours in an optional processing step because, for example, the operator must perform a step manually but has no time to do it, orders that do not require this processing step may be completely processed and issued. Thus, the order throughput with respect to conventional developers in which one order must be fully completed before the next may be significantly increased.

The invention thus works to advantage when the image-processing device of the digital mini-lab includes adequate free computing capacity to perform the optional processing step and other processing steps on other orders. The greater the free capacity for subsequent processing steps, the more orders may be processed in the same time that an optional step requires in one order.

The present invention may especially be advantageously used when the optional processing steps at which the processing sequence of the orders may be changed are realized as completely completed steps. In this case, adequate computing and hard-disk capacity must be available for the optional processing steps in order to process the entire order within this one step; interlacing with other processing steps is to be avoided. Such a completed processing step is thus distinguished in that an order may be completely transferred to the processing step that performs the same step on the entire order, and it may subsequently be transferred to a buffer or to the next processing step as a unit without requiring storage or computing capacity from another processing step during input, processing, or transfer of the order to this processing step.

Entire orders are preferably stored between two processing steps. Thus, entire stored orders are available to subsequent processing steps. If several orders are stored between two processing steps, unlimited access to several orders is particularly possible. This ensures that several orders stored in such a storage device may be searched so that an order that need not pass through one or more subsequent processing steps may be assigned to a step or steps following the unnecessary one if computer capacity is available to perform the subsequent processing step at the moment. The buffer storage between the processing steps must therefore not be configured as FIFO (first in/first out) devices, but rather must ensure free access to all orders stored within it.

In a particularly advantageous embodiment of the method according to the invention, optional and mandatory processing steps are performed in parallel for different orders. This makes it possible not only to perform subsequent processing steps on other orders while one order spends time in an optional processing step, but also while the optional processing step is being performed. This achieves additional time saving. Such parallel processing may be realized in that the image-processing device includes two processors, or multi-tasking processors, that are capable of performing several steps in parallel.

A possible optional processing step in which the procedure based on the invention may be particularly advantageously used is the so-called preview. In a preview, all, or some, images of an order are displayed on the screen so that the operator may evaluate the quality of the images to be printed. In preview mode, the operator may, for example, then perform manual corrections to the images by entering correction values for color saturation, color balance, brightness, gradation, focus, etc. The images thus corrected are again displayed so that the operator can review the result of his/her input. It is also common in preview mode to produce greeting cards, calendars, or other combinations of images with digital files. As soon as the operator is satisfied with the result of his/her manual configuration or correction, the result created in this manual processing step of an order is passed to the next processing step. Such manual input is often very time-intensive, however, since a large number of configuration options are available. In the worst case, it may occur that the operator has no time for such manual input to the images, and the order thus becomes stuck in preview mode without any processing steps being performed on it. This manual processing step is also distinguished by the fact that it needs little of the computing capacity of the image-processing device, but an order within it may wait a relatively long time within this processing step. This very time-intensive but low computer-intensive processing step is thus particularly advantageous for the procedure based on the invention. Since other orders requiring no preview may be promoted and have other processing steps performed on them while an order spends time in preview, these promoted orders may be passed to the digital mini-lab and output with no capacity problems, while the order in preview to be processed is not hindered at all.

An additional especially advantageous optional processing step to be configured is so-called “red-eye correction”. In this step, so-called “red eyes”, or actually pupils, that may be visible in the eyes of persons photographed using a flash are sought out and corrected. A procedure used for this is described, for example, in U.S. Pat. No. 6,278,491. This processing step is also very time-intensive since there is a time-intensive theme-recognition process that must first be performed. No especially large computing capacity is required, particularly when one does not have the entire image data set to perform this procedure, but rather uses a data set with reduced resolution. Thus, it may also be advantageous if orders in which red-eye recognition is not required, since they contain no human subjects, for example, are promoted to the next processing step, whereby such a step in particular may be performed in parallel, and a different sequence results at the next processing step.

In a particularly advantageous embodiment of the invention, the complete image data set of the orders remains stored in the input buffer until just before output. For image processing, a supplemental data set with reduced resolution is formed from each of these image data sets that requires much less storage and computing resources because of its reduced data content. All image-processing steps are performed based on this supplemental data set, and the image-processing parameters required to process a particular data set are stored within each data set. As soon as all parameters required for processing are known, the entire data set is retrieved from the input storage device at the end of image processing, and the image-processing parameters determined from the supplemental data set are then applied to the entire image data set so that a processed, corrected data set results from it. Since the actual image-processing steps, such as for example the algorithm that determines which focus-sharpening parameters are most suited for this particular image, are performed on a reduced supplemental data set, much processing time and capacity may be saved. It is also conceivable to apply this procedure to only one, or a few, image processing steps. Thus, it may be very advantageous for red-eye recognition, which is very computer-intensive, to use only a reduced image data set for face recognition, or for red-eye recognition. Such reduced image data sets are particularly advantageous for the procedure based on the invention since large storage capacities are not required for them.

It is particularly advantageous if a display is provided on the screen, within the scope of the method according to the invention, that shows at least the current image-processing sequence of orders so that the operator may track them. It is especially advantageous if the input sequence of the orders is shown so that the operator can undertake assignment of order input and output of the prints. It is simple for the operator in this manner to assign the scanned films produced from the device in the input sequence to order envelopes that are placed into the sorter in output order.

In a further advantageous embodiment of the invention, there is provision for the operator to influence the processing sequence manually. It may thus be ensured, for example, that the digital mini-lab can handle a so-called express print, i.e., an order that must be produced immediately, with all image-processing steps at the highest priority so that images from this order may be output although other orders were in the middle of being processed in the digital mini-lab, and so that these orders may be bypassed.

In a further advantageous embodiment of the invention, there is provision for the operator to configure the processing sequence for individual processing steps. Thus, the operator may make a setting on the device so that the sequence of orders is always so selected that orders requiring preview are demoted since the operator knows from the outset that he/she has no time for the preview at the moment. Another possibility here, for example, is to process all images at one time in which face recognition and correction procedures such as, for example, color correction of the faces, must be performed so that the operator can control all of them sequentially in preview mode if desired.

It may also be advantageous, however, to have the processing sequence optimized by a control device. The control device monitors the current capacity of the processing station at which the processing steps are performed, the availability of orders to be processed, and the load at output devices. Based on these data, the control device is capable of selecting the processing sequence of the incoming orders so that all orders may be processed in the minimum overall time. Depending on operator input, the control device may also be so configured that an optimal processing sequence is achieved when the output device is always loaded to capacity, or when a specific type of order is to receive preferential treatment. Further combinations are possible here that may be given to the control device in order to optimize the processing sequence.

For a full understanding of the present invention, reference should now be made to the following detailed description of the preferred embodiments of the invention as illustrated in the accompanying drawings.

### BRIEF DESCRIPTION OF THE DRAWING

FIG. 1 is a block diagram showing the stages of the apparatus, and steps of the method, according to the present invention.

### DESCRIPTION OF THE PREFERRED EMBODIMENTS

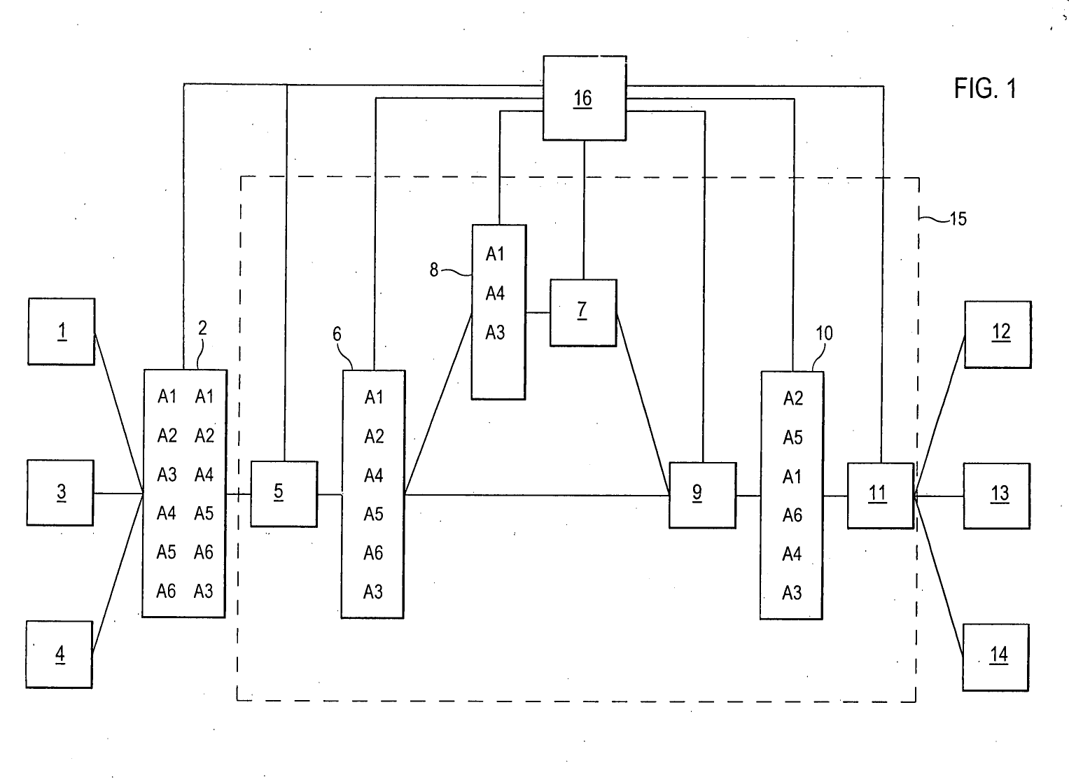

The preferred embodiments of the present invention will now be described with reference to FIG. 1 of the drawing.

FIG. 1 shows schematically the stages and steps of the apparatus and method, respectively, according to the present invention. This apparatus essentially comprises an image processing device 15 for processing digital photographic image data, by order, for the automatic production of prints in a mini-lab. The individual stages or “stations”, as well as the data buffers, of the processing device 15 are each connected to a control device 16 which selects the sequence in which the respective orders are processed. The control device 16 is also connected to an input buffer 2 which supplies image data and order data, associated with each respective order, to the image processing device 15. Under control of the device 16, the apparatus operates as follows:

At an input station 1, digital image data files from a digital camera are read in from the camera memory, are provided with order data that describe the processing steps to be performed along with the characteristics of the prints to be produced, and are compiled with the image data into an order. This order is then transferred to a digital mini-lab connected with the input station, and is stored in the input buffer 2 of the digital mini-lab.

A scanner 3 is located in the digital mini-lab by means of which conventional films are sampled and digital image-data files are created. The image data sets A2 and A3 are subjected to scanner correction after being sampled at the scanner 3. During this correction, systematic errors of the sampling device 3 such as, for example, differing sensitivities of individual sensor elements, are corrected and scratch correction is performed during which the image data are correlated with an infra-red scan performed in parallel in a conventional manner. These image data corrected at input are also stored with pertinent order data in the input buffer 2 as orders A2 and A3. The operator may select the order data for these image data on the user screen before the films are sampled. Furthermore, the digital mini-lab is connected with the Internet, by means of which orders A5 and A6 are transferred by the end customer via a direct network 4. These orders are processed either in the network or upon entrance into the digital mini-lab. This input processing of digital data consists especially of decompression. Several orders A1 to A6 are located in sequence at the input buffer 2. The input orders may now be rearranged at the input buffer 2 of the digital mini-lab in a sequence of A1, A2, A4, A5, A6, A3. Output characteristics, for example, may be taken into account when the processing sequence is established. It may, for example, be useful to move to the end of the processing sequence an order A3 that requires formatting the prints for paper that cannot be realized with the paper currently in the digital mini-lab. As soon as the processing sequence is established, the orders are processed at a first processing stage or step 5 that is mandatory for all orders, such as for example contrast compensation or focus enhancement. Several processing steps may occur here in sequence. After the processing step 5 is complete, the orders are again stored in a buffer 6. After this joint processing step 5 that is mandatory for all orders, an optional processing stage or step 7 is provided that, for example, consists of red-eye correction. Only those order data of orders A1, A4, and A3 indicate that these orders must be subjected to red-eye correction. Thus; these orders are transferred to another buffer 8 in order to perform red-eye recognition 7 on them. It is also possible that the orders remain in the buffer 6 for awhile, and from there only those orders are forwarded to the processing stage or step 7 for which red-eye correction is indicated. Thus, an additional buffer 6 may be obviated. While these orders A1, A4, and A3 of the series are subjected to a red-eye recognition procedure, based on the invention, the other orders for which this processing step is not required (orders A2, A5, and A6) are subjected to the next processing stage or step 9. In processing stage/step 9, which for example may consist of color correction, order A2 is processed first since A1 is being investigated in stage/step 7 for red eyes. In buffer 10, in which the orders processed in stage/step 9 are stored, order A2 is established as the first order. The processing sequence thus changed between the buffers 6 and 10. If red-eye correction is very time consuming, during the time when A1 is corrected, another order A5 may undergo color correction in processing stage/step 9. While color correction was being performed on A5, order A1 was corrected in stage/step 7, and can be the next to undergo color correction in stage/step 9. Thus, order A1 is stored in buffer 10 as the next for further processing.

Correspondingly, the other orders are processed so that the processing sequence A2, A5, A1, A4, and A3 results at the buffer storage unit 10, which was the determining factor for processing in stage/step 9 (color correction). The input sequence A1 through A6, the original processing sequence, and the altered processing sequence that currently reigns in the buffer 10 are displayed on the operator screen (not shown). If the operator does nothing, the orders are transferred to a processing stage/step 11 in the color palette of the desired output device. The output may be to a CD burner 12 in which all, or only selected, orders are copied onto CD-ROMs. In the normal case, however, all orders are sent to a printer 13 from which prints of the images are created. This printer may include a projector such as a laser illuminator, a LCD-, DMD-, or other modulated-light projector or an LED projector or similar projection device known in the art. If the printer 13 consists of a projector onto light-sensitive image material, then a developer unit in the digital mini-lab is connected to the projector. After exposure, the prints are developed and transferred by order into folders. Another option for order output consists of connecting the digital mini-lab with the Internet. The processed image data may be transferred directly to the end customer via the Internet.

The processing stages and steps in the embodiment shown in FIG. 1 were chosen merely as an example. Instead of red-eye correction, an optional processing step may consist of a preview with manual image processing, or merely a preview of the images. Instead of this processing step, or in addition to it, an optional processing step may consist of any other known image-processing procedure if they are not to be applied to each order, but rather only be performed when so specified in the order data or if determined during image processing that this processing step would be advantageous to the resulting image. Thus, an optional processing step may also consist, for example, of focus enhancement if the image grain was examined in advance in order to determine whether focus enhancement is to be performed on a particular image or not. Thus, for example, it may be disadvantageous with very grainy images to enhance the focus. Optional and mandatory processing steps may be arranged in any sequence without influence on the procedure based on the invention. The orders also need not mandatorily pass through one processing step after the other to the point of output. It may easily be provided that, for example, after complete processing of an image, it may be determined during preview that red-eye correction was necessary with this order, although such was not specified in the order data. In such case, the order would be placed again at the beginning of the processing sequence, or inserted before red-eye correction, along with other orders, and would pass through image processing a second time. Even in this case, other orders could still be promoted in the sequence during this time.

There has thus been shown and described a novel method and apparatus for the automatic production prints from digital photographic image data which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. In a method for the automatic production of prints from digital photographic image data, comprising the steps of:
storing incoming image data by order, together with order data for use in processing in a processing sequence;
processing the image data by order based on the processing sequence, wherein the processing sequence includes mandatory processing steps that image data from all orders must pass through and may include optional processing steps that image data from specific orders must pass through; and
producing prints from the processed image data;
the improvement wherein the processing sequence of the orders is altered for subsequent processing steps if the image data of an order are required to pass through an optional processing step.

2. Method as defined in claim 1, wherein the processing sequence is altered in dependence upon the capacity of subsequent processing steps.

3. Method as defined in claim 1, wherein optional processing steps are performed independently of the progression of other processing steps.

4. Method as defined in claim 1, wherein orders are completely stored between processing steps.

5. Method as defined in claim 1, wherein optional and mandatory processing steps are performed in parallel.

6. Method as defined in claim 1, wherein an optional processing step comprises of manual processing on an operator's screen.

7. Method as defined in claim 1, wherein an optional processing step comprises automatic recognition of the red-eye effect.

8. Method as defined in claim 1, further comprising the steps of creating reduced supplemental data sets for processing of image data and processing parameters from said supplemental data sets.

9. Method as defined in claim 1, further comprising the step of providing, as a mandatory processing step, an end processing step in which the image-processing parameters are applied to the entire data set in order to create image data for the prints.

10. Method as defined in claim 1, further comprising the step of displaying the altered processing sequence on the operator's screen.

11. Method as defined in claim 10, further comprising the step of manually selecting the processing sequence for all processing steps.

12. Method as defined in claim 10, further comprising the step of manually selecting the processing sequence for individual processing steps.

13. In apparatus for the automatic production of prints of digital photographic image data, said apparatus comprising:
(a) an input device for the input of image data and accompanying order data;
(b) an input buffer for storing several orders;
(c) an image-processing device for processing image data by order; and
(d) an output device for producing prints of the processed photographic image data;
the improvement wherein the image-processing device includes several image-processing stations for the processing of at least one order, along with buffer storage between image-processing stations in which at least two orders may be completely stored, said apparatus further comprising a control device, connected with the image-processing stations, for altering the sequence of the orders being processed.

14. Apparatus as defined in claim 13, wherein the control device is connected with the input buffer so that the processing sequence may be manually selected.

15. Apparatus as defined in claim 13, wherein the image-processing device includes at least two processors.
